(19) United States
(12) Patent Application Publication
(10) Pub. No.: US 2016/0260021 A1
(43) Pub. Date: Sep. 8, 2016

(54) SYSTEM AND METHOD FOR IMPROVED AGRICULTURAL YIELD AND EFFICIENCY USING STATISTICAL ANALYSIS

(71) Applicant: William Marek, Bountiful, UT (US)

(72) Inventor: William Marek, Bountiful, UT (US)

(21) Appl. No.: 15/041,301

(22) Filed: Feb. 11, 2016

Related U.S. Application Data
(60) Provisional application No. 62/129,558, filed on Mar. 6, 2015.

(51) Int. Cl. G06N 7/00

(52) U.S. Cl. CPC G06N 7/005

(57) ABSTRACT

A method and system for adjusting inputs to an agriculture field to improve crop performance. Data are gathered for a field divided into zones, which may be sector-shaped or otherwise. These data include field characteristics, grower inputs, and yield. Statistical techniques are applied to (1) identify grower inputs that correlate with crop performance; (2) identify zones that may benefit from adjustments to one or more grower inputs; (3) predict improvements in crop performance that may result from adjusting one or more grower inputs for a particular zone; (4) suggest an adjustment to one or more grower inputs for a particular zone; (5) analyze actual effects of applying adjustments to grower inputs for a particular zone; (6) determine whether a zone may benefit from further tuning one or more grower inputs; and (7) suggesting tuning adjustments to one or more grower inputs for a zone. A method and system for computing “Sure Pressure”, i.e., for computing pump motor speed and consequently water pressure that ensures sufficient pressure for each dropdown in a span in a center-pivot irrigated field, is also disclosed.

This application claims the benefit of U.S. Provisional Application No. 62/129,558 filed on Mar. 6, 2015.

### FIELD OF THE INVENTION

This invention is directed to increasing yield and efficiency in agricultural applications through statistical analysis of field characteristics and grower inputs. The disclosed analysis makes use of decision science tools and provides (1) diagnostic, (2) evaluative, and (3) prescriptive components that can be used for (a) identifying locations and causes of sub-optimal yield, (b) identifying and taking alternative corrective action, (c) making investment decisions relative to precision equipment, technology, or solutions, and (d) tuning inputs to improve yield and efficiencies. The prescriptive component may comprise quantitative modifications to variable grower inputs including (1) tillage, (2) fertility treatment(s), (3) seeding density/spacing, and (4) irrigation.

### BACKGROUND OF THE INVENTION

Commercial agriculture begins with a field, which may be irrigated or unirrigated. An irrigated field may be, as is typical in commercial agriculture, a “quarter section,” which is one-quarter mile by one-quarter mile, covering 160 acres. Although a quarter section is typical, other sizes and shapes of fields exist and are commonly used for commercial agriculture.

A field has multiple characteristics including, but are not limited to, chemistry, topographic conditions, geo-referenced crop yield, Normalized Differentiated Vegitative Index (NDVI), and other characteristics known in the art. Chemistry characteristics of soil may include, but are not limited, electro-conductivity (EC), Ph, macro-nutrients (NPK) and micro-nutrients (include boron (B), zinc (Zn), manganese (Mn), iron (Fe), copper (Cu), molybdenum (Mo), chlorine (Cl)), and other chemical properties of soil known in the art. Topographic conditions may include elevation, landscape change, slope, aspect, soil compaction, and other conditions known in the art, and may be based on or measured with Real-Time Kinematic (RTK) or satellite-corrected (RTX) elevation values, or derived topographic GIS data layers. Soil characteristics may be derived from Electrical Conductivity (EC)/Electro-magnetic Imaging (EM) mapping, and generally address both subsoil (typically defined as 12-36″) and topsoil (typically defined as 0-12″).

Growing plants or crops requires applying inputs to a field. Such inputs include, but are not necessarily limited to, irrigation, tillage, fertility/chemical treatment, and seeding.

Tillage may comprise traditional ripping, disking and furrowing, strip-till or no-till.

Fertility/chemical treatment may comprise fertilizers, pesticides, herbicides, fungicides, and soil amenities.

Seeding may comprise spacing density, depth, type of seed, seed coatings, and other factors known in the art.

Irrigation may comprise location, frequency, timing, amount, and other factors known in the art.

Crop yield is conventionally measured in bushels-per-acre (volumetric measures) for small grains (e.g., wheat, barley, soybeans, and corn) and mass values (either tons or lbs. per acre) for other crops (e.g., alfalfa, sugar beets, potatoes, and onions). Current combine technology can track yield by geospatial location. Root crop harvesters can also be configured with “load cells” to provide and track similar yield data. Geospatial data is important for evaluating effects of grower inputs in (1) seeding varieties and spacing/density, (2) fertility application, (3) tillage practice, and/or (4) water volume. Geo-referenced NDVI data has been effectively used as a proxy for yield data when yield data is not available.

Commercial agriculture is a complex endeavor in which growers must determine, for vast acreage, (1) which crop(s) to grow; (2) which varieties of particular crops to grow; (3) when to plant; (4) how to prepare the soil; (5) volume, frequency, and timing of irrigation; (6) application and timing of fertility treatments; (7) application and timing of insecticide/herbicides; (8) how to deal with weather patterns and unexpected weather events; and (8) how to deal with variations in soil, topography, elevation, and environmental conditions impacted by field positioning and orientation.

Dealing with even one of these issues is difficult and complex. But dealing with all of these issues, especially when it is recognized that field characteristics vary over the dozens or even hundreds of fields for which a grower may be responsible, is intractable. Also, slight modifications to grower inputs, e.g., increasing or decreasing irrigation or fertility treatment or another grower input, may significantly impact the effect other inputs (interactive effects) and consequently yield.

The commercial agriculture industry has heretofore emphasized uniform application of grower inputs (e.g., tillage, seeding, fertility treatment, and irrigation), generally ignoring variability in field characteristics. This emphasis on uniform application and maintenance of inputs has, within a single generation, catapulted agriculture yields and quality beyond even the most optimistic expectations. Uniform treatment across an entire field frequently results in non-uniform yield, however, because of the non-uniformity of field characteristics.

One example of uniform irrigation is a center-pivot sprinkler system. In a quarter section, a center-pivot sprinkler irrigation system reduces the total 160 acres by approximately 40 acres (the area inside the square field but outside the circular irrigation coverage area), resulting in approximately 120 irrigated acres per quarter section. With uniform water distribution, both the timing and volume of the irrigation system are typically set to address the most trying portion of the field (e.g., sandy ridges, which typically require more water for optimal yields). With this approach, and by definition, the field is over-watered on those portions of the field that are lower in elevation and have loam or more clay-like soils, or that for any other reason may have lower watering needs. As is well-known in soil science, loams and clays have more pores, and therefore have better water holding capacities than sandy soils. Overwatering not only wastes water and power, but also potentially flushes nutrients through the root zone, provides a breeding ground for disease, lowers soil temperature, and can thereby actually decrease crop yield.

In recent years, to address the problem of non-uniform yield and sub-optimal yield, growers have modified or customized grower inputs. They have made these changes by applying “rules-of-thumb,” relying on historical precedent or experience, relying on grandpa's best advice, imitating what the neighbor is doing, or by using guidance or suggestions from experts from the NRCS (Natural Resources Conservation Service), soil conservation districts, or a local university extension service.

Applying appropriate volumes of water promotes improved germination and growth, minimizes disease and optimizes yield, and also improves the “sustainability profile” by applying the appropriate amount of water to maintain optimal levels of Plant Available Water (PAW) in the root zone area.

The notion of customizing inputs to field characteristics is a promising approach, reflected in the recent emergence of precision agricultural practices including, e.g., GPS-guided equipment, variable-rate planters, geo-referenced yield monitoring, variable-rate fertility treatment (VRF), and variable rate irrigation (VRI).

With VRI, instead of watering uniformly across an entire field, watering volume is varied by sector (as, for example, in a center-pivot sprinkler system). VRI addresses and corrects, to some extent, overwatering and under-watering, by customizing watering according to the unique requirements of each sector. Precision input approaches have also been used on polygon-zoned fields.

Equipment providers have expanded their product lines to include GPS capabilities. Today's tractors, spreaders, and implements support precision and non-uniform application of growing inputs. Non-uniform precision input application is not limited to field equipment, and can include aerial application of inputs (e.g., herbicides, pesticides, fungicides and fertility measures) through terrestrial-based spray planes and, more recently, large scale drones as well.

Customized, or precision, inputs may be applied by dividing a field into zones. Such zoning, e.g., by sectoring geo-referenced acreage, is a standard and widely-used approach in commercial agriculture, and is supported in both commercial and open-source Geographic Information System (“GIS”) software packages. A typical approach for zone-sectoring a quarter section with center-pivot irrigation is to divide the circular field (i.e., the irrigated portion of the quarter section), into 60 wedge-shaped sectors, each comprising 6° of the 360° circle. A person of ordinary skill will appreciate that sectors could be sizes other than 6°, and could also be variable sizes, e.g., some sectors may be 2°, some may be 6°, some may be 10°, etc.

Other fields may be divided not by sectors, but into polygon-shaped zones based on field characteristics as described above. A field may be divided into polygonal zones based on, for example, one or more field characteristics, e.g., soil Electro-Conductivity (“EC”), field topology, or a combination of EC, soil chemistry and field topology. Zones of other shapes, or resulting from other field-division approaches, are within the knowledge of a person of ordinary skill, who will appreciate that, in general, a field may be divided into zones in many different ways, e.g., to accommodate equipment such as a center-pivot irrigation system, based on exposure to prevailing winds and/or solar radiation, based on elevation, based on compass orientations, based on soil characteristics or other field characteristics, or based on any other factor or combination of factors as understood in the art.

These approaches, as described herein above, have improved input application efficiency and crop yield, but fail to provide quantitative analysis as to which field characteristics correlate with yield, the extent to which field characteristics correlate(s) with yield, and the extent to which a modification to grower inputs causes a change in yield along with the magnitude of that change.

Currently, a grower may believe that a modification to a particular grower input caused an improvement in yield, quality, pedal samples, or other performance characteristics, but the grower is without quantitative evidence to support, confirm, or justify such beliefs.

There exists a need to quantitatively and statistically determine (1) which field characteristics and/or grower inputs correlate with yield and other performance metrics, as well as the extent of such correlation; (2) the probability that, and the potential extent to which, a change to a grower input may affect yield; (3) potential financial benefits from one or more changes to grower inputs; (4) the actual impact of a change to a grower input on crop performance and (5) the impact of a change as it relates to the efficiency with which inputs can be applied for optimal utilization.

Also, for years it has been recognized that the water pressure measured in Pounds Per Square Inch (PSI) delivered to the pivot point is not necessarily the correct amount delivered to the dropdowns throughout the pivot span of approximately 1,300 feet (on a typical quarter section center pivot). This non-uniformity is a function of both friction loss and dynamic head gain/loss. It is not uncommon for this to occur where the topography includes elevation changes under the center pivot. Installing multiple transducers on each tower (or even every other tower) is cost-prohibitive. There exists a need to ensure minimum necessary PSI is delivered to each dropdown on a pivot span for optimal water delivery by the center pivot.

### SUMMARY OF THE INVENTION

This invention builds on precision agricultural practices by disclosing a system and method for quantitative analysis of field characteristics and yield data, prescription of adjustments to grower inputs, and financial analysis of such precision solutions. The invention disclosed herein (1) statistically identifies field characteristics that correlate with sub-optimal and optimal crop performance; (2) assesses the potential effectiveness of an adjustment to one or more grower inputs; (3) prescribes a statistically-based precision solution comprising adjustment(s) to one or more grower inputs; (4) provides a prospective cost-benefit analysis for applying the precision solution; and (5) quantitatively assesses the actual effect of an applied precision solution on crop performance and the efficient management of inputs.

In addition to improved crop performance, this invention promotes preservation of natural resources such as water and associated electric power requirements to lift and push water.

The precision solution may comprise, but is not limited to, adjustments to irrigation, tillage, fertility treatment, seeding, or any other grower input. In addition to these specifically identified grower inputs, this invention accommodates other grower inputs known in the art.

A prescription is generated based on standard stepwise regression techniques to derive correlation coefficient(s), confidence interval(s), residual value(s), and normalized coefficient(s) for mitigating risk through precision application of grower inputs.

Additionally this invention provides the methodology for calculating a new data layer that allows the grower to precisely manage Variable Frequency Drives (VFD) to the motor load by precisely prescribing the correct Hz the motor must turn to meet end-of-system PSI requirements for optimal volumetric water distribution.

A preferred embodiment may comprise three foundational components: (1) Field Data Analytics (“FDA”), (2) Prescription Calculator, and (3) Evidence-Based Analytics (“EBA”). These components may be applied regardless of whether the field is divided into sectors, polygons, or other shapes or combinations of shapes.

The FDA may (a) correlate field characteristics and grower inputs with crop performance; (b) identify zones that warrant attention; and (c) determine the magnitude of potential benefit from modifying grower inputs. Crop performance may be measured by yield, NDVI, or any other known crop performance measurement. Sources of yield data include, but are not limited to, geo-referenced yield data.

The Prescription Calculator may (a) identify one or more grower inputs for adjustment and (b) generate and/or “prescribe” an adjustment to grower input(s). In one embodiment, the Prescription Calculator uses “regression-to-the-mean” to generate recommended adjustments to grower input(s).

The third foundational component is Evidence-Based Analytics (“EBA”), which is used after application of a precision solution to (a) evaluate the actual effect of a precision solution and (b) prescribe modifications to “fine-tune” the precision solution.

This invention also includes an entirely new mathematically derived GIS data layer called “Sure Pressure” (“SP”). SP identifies the dynamic head gain or loss along the entire span by individual degree throughout all degrees traversed by the center pivot. Friction loss to the max/min points on the pivot span is also calculated. Taken together SP solves the problem of the often ignored change in PSI to the dropdowns further away from the pivot point. With SP, PSI is delivered to the rated capacity of the regulators on the dropdowns, regardless of whether a particular dropdown is near to or far from the pivot point. This means that the designed delivery of water matches the actual delivery of water. When SP is used in conjunction with a (1) Variable Frequency Drive (VFD) and (2) GPS pivot coordinate heading (bearing) equipment, the pump motor load can be optimized for both energy and water efficiency. SP is the minimum PSI for each given degree the pivot span transverses. SP ensures that each dropdown in that span has correct PSI. The SP is calculated by employing well-known mathematical and engineering approaches based on dynamic head and friction loss in a pivot span. Finally, SP may be used as an independent variable in the FDA regression modeling described herein below.

### BRIEF DESCRIPTION OF THE DRAWINGS

FIG. 1 shows the principal components of a preferred embodiment of the invention disclosed herein: Field Data Analytics (“FDA”), Prescription Calculator, and Evidence Based Analytics (“EBA”).

FIGS. 2A and 2B represent different schemes for dividing a field into zones. FIG. 2A shows a field divided into 16 sectors. FIG. 2B shows a field divided into polygonal-shaped zones.

FIG. 3 shows the steps that may be performed by the FDA.

FIG. 4 shows the steps that may be performed by the Prescription Calculator.

FIG. 5 shows the steps that may be performed by EBA.

### DETAILED DESCRIPTION OF THE INVENTION

The invention described herein comprises a system and method for quantitatively (1) correlating field characteristics and grower inputs with crop performance (e.g., as measured by geo-referenced yield and/or NDVI); (2) prescribing a precision solution to improve crop performance, where the precision solution comprises one or more modifications to grower inputs; (3) predicting benefits to crop performance from applying the precision solution; (4) analyzing the actual effects from application of a precision solution; (5) assessing the impact of a change as it relates to the efficiency with which inputs can be applied for optimal utilization; (6) prescribing adjustments to tune a prescription solution; and (7) creating a GIS data layer that employs the elevation derivatives for each 1° sector (or otherwise-defined degree increments) to calculate the frequency at which the VFD pump motor load must operate at for delivery of optimal PSI throughout the length of the tower spans and ultimately to each of the pivot dropdowns.

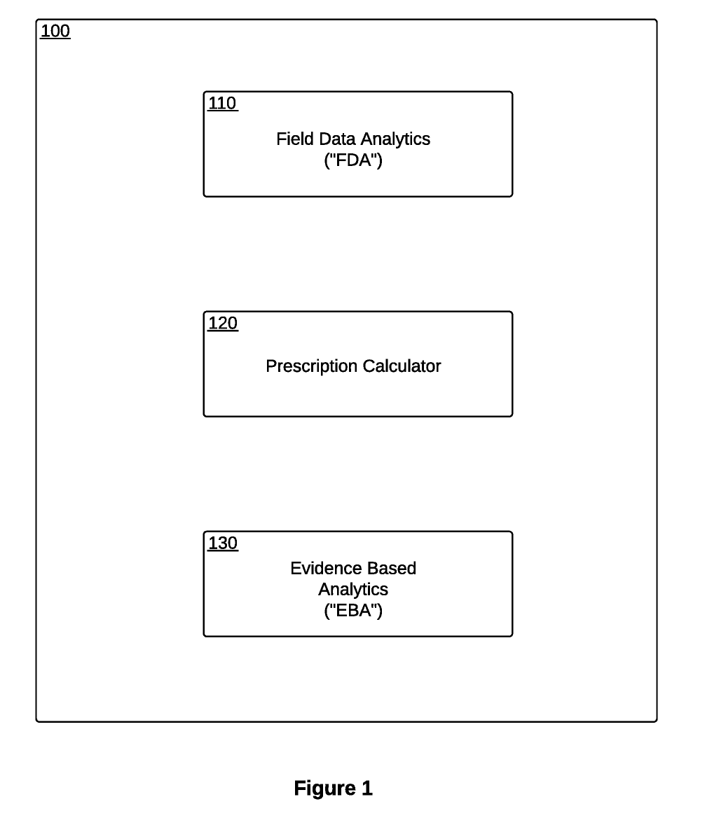

FIG. 1 shows a preferred embodiment 100 of this invention, which may comprise three components: Field Data Analytics (“FDA”) 110, Prescription Calculator 120, and Evidence-Based Analytics (“EBA”) 130. These components are presented merely for the sake of convenience in describing the invention herein. The functionality, steps, and parts of the invention disclosed herein could be organized differently, or grouped in different ways or component groupings, or with different names or naming conventions, without changing the scope of the invention.

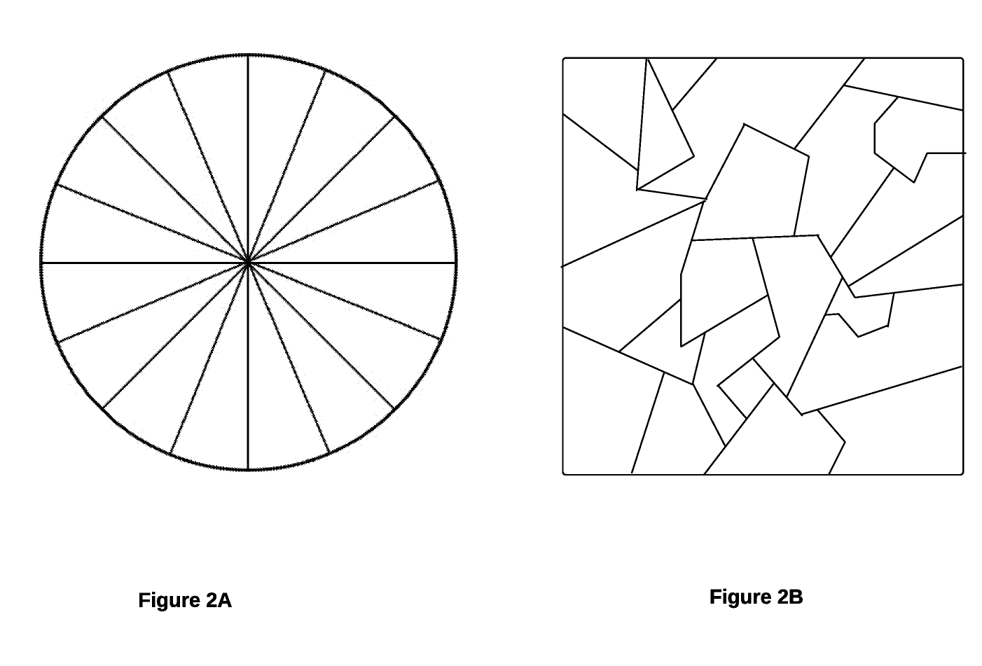

An agriculture field may be divided into sectors (as in center-pivot irrigation) or polygons, or according to any other scheme for dividing a field into zones. FIGS. 2A and 2B show exemplary divisions of an agriculture field. FIG. 2A shows a field divided into 16 sectors. The number of sectors in FIG. 2A, i.e., 16 sectors, is exemplary, and is used here merely because it is useful and illustrative. A field may be divided into any number of sectors, and is frequently divided into 60 sectors, each representing a 6° wedge. FIG. 2B shows a field divided into polygons. This invention applies to any agriculture field, regardless of how it is divided.

In a preferred embodiment, the FDA may (a) correlate field characteristics and grower inputs with crop performance; (b) identify zones that warrant attention; and (c) determine the magnitude of potential benefit from modifying grower inputs. Crop performance may be measured by yield, NDVI, or any other known crop performance measurement. Sources of yield data include, but are not limited to, geo-referenced yield data.

The Prescription Calculator may (a) identify one or more grower inputs for adjustment and (b) generate and/or “prescribe” an adjustment to grower input(s). In one embodiment, the Prescription Calculator uses “regression-to-the-mean” to generate prescribed adjustments to grower input(s).

The EBA may be used after application of a precision solution to (a) evaluate actual effectiveness of the precision solution and (b) generate adjustments to tune grower inputs.

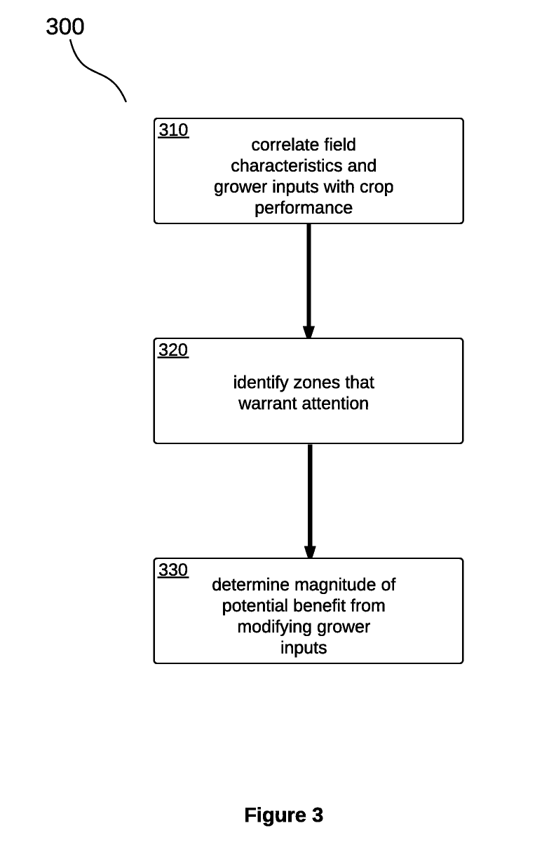

FIG. 3 shows an exemplary process, or set of steps, that may be performed by the FDA. FIG. 3 does not limit the steps that FDA may perform, or the ordering of steps, or omission of steps, but merely represents one possible embodiment of the invention.

At step 310, the FDA may correlate field characteristics and grower inputs with crop performance. The FDA may do this by using multiple linear regression and/or stepwise regression statistical techniques.

The FDA may employ stepwise regression to identify the independent variable(s) (e.g., field characteristic(s) or grower input(s)) that most strongly correlate(s) with crop performance. FDA may also rank or partially rank some or all independent variables, or sets of independent variables. With stepwise regression, FDA may begin with multiple independent variables and successively narrow down the independent variables until one or more significant independent variables are identified. Depending on a particular application, the stepwise technique could be designed to identify any number of most significant (i.e., highly correlating to yield) independent variables. The stepwise technique could be deployed stepping-up or stepping-down, determining one or more independent variables together with their correlation coefficient (r²), adjusted r², F-test, individual independent variable coefficients, residuals, and/or p-values, which are standard in virtually all statistical software packages and tools.

In general, stepwise regression is an iterative approach in which one or more “poor regressors,” (i.e., independent variables which do not correlate strongly with yield), are removed at each iteration of a model run. For example, in a first iteration each independent variable may be tested independently as a regressor against yield value. A correlation coefficient may be determined for each independent variable, and the independent variables with low or marginal correlations are iteratively tested in combination with each of the other independent variables. If it is determined that an independent variable has poor explanatory value, i.e., does not correlate strongly with yield, that independent variable is discarded from the stepwise regression. Again, virtually all statistical software packages and tools offer and support this functionality. A correlation value for an independent variable may be determined. The correlation coefficient may be used in combination with the p-value to assess the relative “importance” of the variable impacting yield. Many variations of stepwise regression are well-known in the art. A stepwise algorithm procedure for statistical model selection where more than one variable could possess explanatory capability.

The FDA may provide a “percent confidence” for one or more of the independent variables, or for one or more sets of independent variables. This “percent confidence” is the probability (confidence level) that the same results for an independent variable, or set of independent variables, would occur if a new sample selection were prepared.

The output of this stepwise regression may be an independent variable, or set of independent variables, that most strongly correlates with yield. This may be referred to as the “determinant,” i.e., the independent variable, or set of independent variable(s), that has the greatest ability to explain (account for) yield/NDVI.

At step 320, the FDA may identify one or more zones whose performance is sub-optimal, or which may for any other reason warrant attention or possible adjustment to grower inputs. In one embodiment, the FDA may identify sub-optimally performing zones through regression. These sub-optimally performing zones, and associated regression, may be plotted on a scatter plot. Multiple regression techniques and methods known in the art may be applicable here. Such regressions techniques may include, but are not necessarily limited to, linear regression, logistic regression, polynomial regression, stepwise regression, ridge regression, lasso regression, and elastic-net regression.

In one embodiment, the FDA may perform a linear regression and, based on the outputs, may distinguish zones with average yield from zones with non-average yield. “Average,” as used herein, does not refer to the statistical average or mean, but refers to the idea of acceptability or reasonability, or any other meaning that may be ascribed by a grower or user under particular circumstances. “Average” may be user-defined, or defined in some algorithmic or computational manner as is well-known in the art. For example, in one embodiment, average may be defined as yield values greater than the lowest quartile of all yield values. The mean value for all values within the lowest quartile can also be calculated. The difference between the lowest quartile mean difference for the entire array and the mean values falling within the lowest quartile can be calculated. The coefficient for the individual variable and the difference between the lowest quartile and the total array mean value can be multiplied producing a “net coefficient” for the field. The total acres impacted and total bushels impacted can then be calculated. This value can be further multiplied by the current price for the crop, e.g., in dollars/bushel. A quantitative predictive statement can then be prepared to inform the grower on the net bushels, acres, and financial impacts as a result of a per unit change in the independent variable. In some embodiments, FDA may normalize independent variable(s) and/or yield values to facilitate statistical analysis, ranking, or comparisons.

At step 330, the FDA may generate a predictive estimate of improvements in crop performance that may result from modifying one or more grower inputs. The FDA may do this by (1) calculating the mean residual value for zone yields that are beneath the regression slope; (2) taking the product of the r² (correlation coefficient) and the mean residual value beneath the slope, where this mean residual value constitutes the max crop volume per area (e.g., bushels/acre) that can be realized on this field excluding any improvement on those field zones that are above the slope; (3) dividing the output from step 2 immediately above by the mean volume/acre (i.e., bushels/acre) over all zones in the field (wherein the mean volume/acre is computed from the yield data); and (4) optionally applying a “percent modifier” to adjust the result. A grower or other party may use the “percent modifier” to adjust the predictive estimate, e.g., if a grower feels as though the model is too conservative by not taking into consideration those values above the slope, the percent modifier can be adjusted to something greater than 100%. The “percent modifier” may also be set to something less than 100% if the grower feels the model is overestimating potential benefits. The percent can then be applied to the known and/or typical yield to determine the amount of additional crop volume/area. These quantities are easily dollarized according to present, projected, or otherwise estimated or known prices for a particular crop.

Other measurements, or means of measuring, other than bushels per acre, may be used depending on the particular crop and what may be customary for a particular crop.

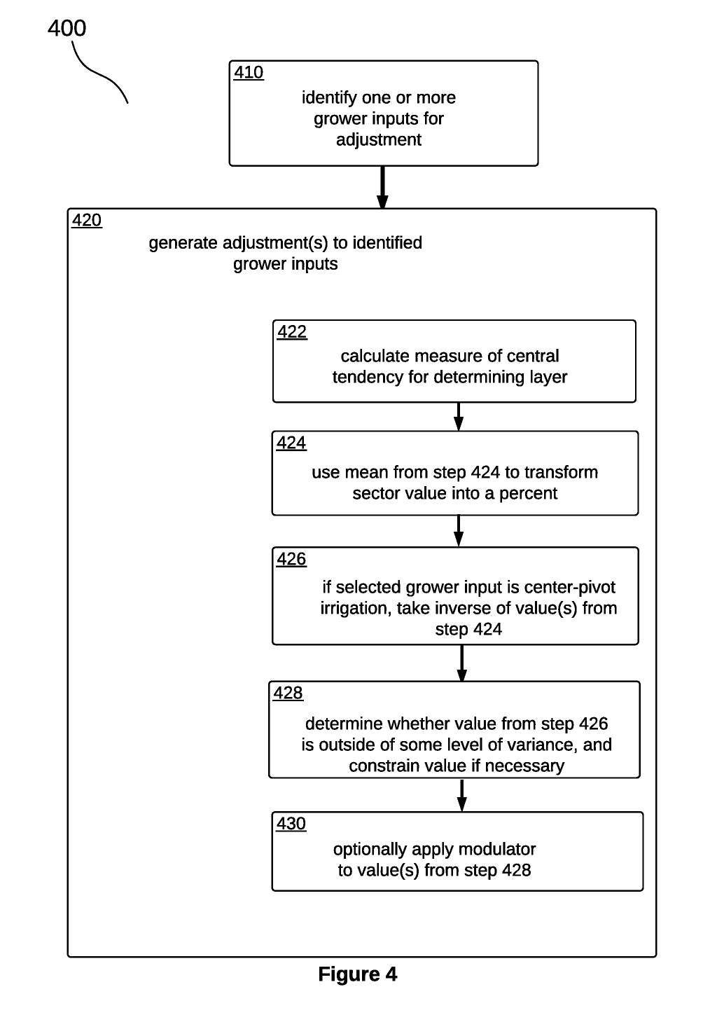

Referring now to FIG. 4, at step 410, the Prescription Calculator may determine one or more grower inputs for adjustment. In one embodiment, the Prescription Calculator may receive the selected grower input(s) for modification from a grower, or from some other person who may have knowledge about the field (e.g., agronomist or farm/irrigation manager), or experience with the field, or who may otherwise have expertise or knowledge facilitating an educated decision regarding which grower input(s) to adjust. In another embodiment, the Prescription Calculator may determine the grower input for adjustment by selecting a default, e.g., irrigation, or by selecting a grower input that has not recently been modified, or by cycling through grower inputs available for modification.

At step 420, the Prescription Calculator may determine a precision solution, i.e., generate adjustment(s) to identified grower input(s). In one embodiment, the Prescription calculator may generate a precision solution according to steps 422-430 in FIG. 4. At step 422, the Prescription Calculator may calculate a measure of central tendency (mean/median) for the determining layer. At step 424 Prescription Calculator may use the mean calculated in step 422 to transform each individual zone value into a percent by dividing the zone value by the measure of central tendency for the entire array, i.e., for the entire set of zones. If the selected grower input is irrigation and it is measured by pivot speed, at step 426 the Prescription Calculator may take the inverse of those values from step 424. This is done because to apply more water, a center pivot must have greater resident time in that sector, which requires a slower pivot speed. The value from this step is a percent. To translate into an appropriate volumetric water prescription this value may be multiplied by a grower-determined “base rate” application.

Next, in step 428, the Prescription Calculator may algorithmically determine whether the value from step 426 is outside of a user-determined amount of variance. If this prescriptive adjustment is beyond the user-determined variance, both the percent and the volumetric amount of change may be constrained by “regressing-to-the mean” those prescriptive adjustments which would otherwise either remove or add volumes of water outside a pre-determined variance parameter.

In one embodiment, at step 430, the Prescription Calculator may provide an option for applying a “Modulator” to a prescribed adjustment. A Modulator is an increase or decrease, or other adjustment, to a prescribed change. For example, a Modulator may increase or decrease a prescribed change by a factor or percentage, i.e., “scale” the prescribed change, or may increase or decrease a prescribed change by modifying percent, standard deviation, z-score, stanine, quartiles, or any recognized measure for scaling which may be appropriate. In general, a Modulator allows a user, or automated interface such as a computer, to modify a prescribed adjustment. This may occur, for example, when a grower has additional information about a particular zone, or just has a “hunch,” e.g., based on experience, that a prescribed change should be made.

Depending on the controller that will be used, the Prescription Calculator may transform the output into the appropriate user-defined controller protocol.

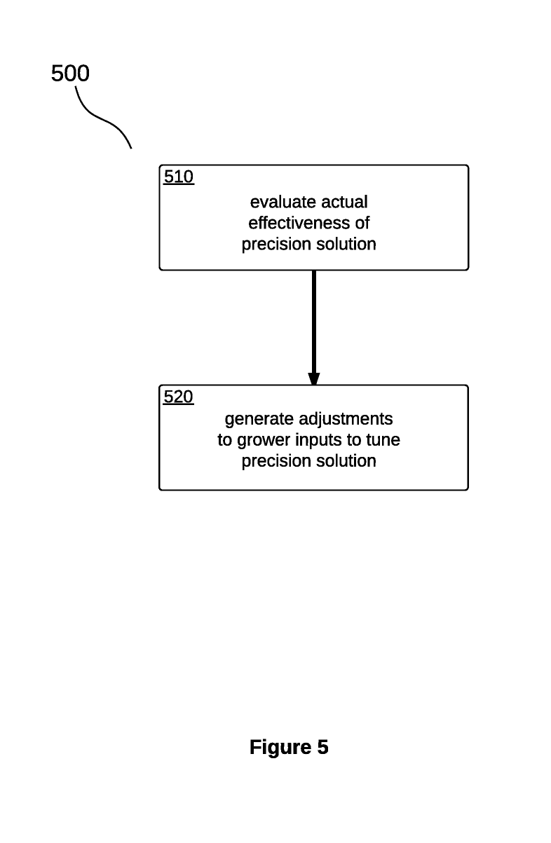

Referring now to FIG. 5, after a prescription has been actually implemented, e.g., for a growing season, the EBA may evaluate the actual effectiveness of the prescription, to direct the grower's attention to those parts of the field that need additional attention and also to generate suggested adjustments to grower inputs to tune or refine the prescription.

In one embodiment, at step 510 the EBA may determine actual effectiveness of the prescription by determining whether the yield for the zone has improved, and whether the improvement is statistically significant.

In determining actual effectiveness an “average” may be defined as yield values between the 25^{th} and 75^{th} percentiles of all yield values for a set of zones. Different percentiles may be used for the definition of “average”, e.g., 40^{th} and 60^{th}, 35^{th} and 60^{th}, or any other percentile range. The definition of “average” may be refined or tuned iteratively, at pre-defined intervals, or in any other manner known in the art using standard measures of statistical variance. Percentile analysis is well-known in the art.

In one embodiment, the EBA may classify data points that are below average, e.g., zones with a below average yield, as being “low-yield,” and may classify data points that are above average, e.g., zones with an above average yield, as being “high-yield.”

The EBA may further determine a data point's (zone) dispersion, or residual value, from the regression trendline (slope). In one embodiment, this dispersion value may be used in conjunction with the classifications described above, i.e., “low-yield,” “average-yield,” and “high-yield,” to identify zones that are performing well, or that may warrant further attention, investigation, or modification. For example, in one embodiment, a zone may be classified as “low yield” or “high yield” only if its dispersion from the regression line is greater than some predetermined distance. This predetermined distance may be, greater than or less than the array measurement of the 25^{th} and 75^{th} percentiles, or of any other range of percentiles.

A person of ordinary skill will appreciate that, instead of using a “low,” “medium,” and “high” classification system, discrete or continuous numerical values could be assigned to zones for yield and/or NDVI. These values could be normalized. A person of ordinary skill will further appreciate that multiple other variations on ranking approaches, or approaches for assigning relative or absolute strengths to yield, could be employed.

As already emphasized above, limits such as the 25^{th} and 75^{th} percentiles are merely exemplary, and may be set as different points as appropriate for a particular application and as may be understood by one of ordinary skill. In one exemplary embodiment, the EBA may assign one of multiple levels of severity to a zone, e.g., a zone with a yield falling outside of one standard deviation but within two standard deviations may be classified as a zone needing attention, analysis, and/or modification, and a zone with a yield falling outside of two standard deviations may be classified as a zone severely in need of attention, analysis, or modification.

At step 520, the EBA may generate adjustments to tune a prescription for a zone. Tuning adjustments for a zone may be based on the zone's residual values. For example, a prescribed change in irrigation volume for a zone where the current value of the irrigation volume is x units above the regression line may call for a decrease of x units. If the current value of the irrigation is y units below the regression line, then the change to the irrigation prescription may be an increase of y units. In this manner, the irrigation prescription is based on the residual of the respective zone and the volume of change required to comport to the regression slope.

The actual change for a prescription, or for tuning a prescription, may be implemented in a variety of ways known in the art. For example, the change in grower input for a zone may be implemented or shown as the percent change from a current value, or the amount of increase or decrease, an absolute value, or in any way that may communicate or represent the change to be implemented.

The Sure Pressure (“SP”) for a particular pivot span is the minimum PSI to the pivot point necessary to ensure that the entire span and all dropdowns in the span receive sufficient PSI to meet design specifications of the sprinkler regulator. SP may be calculated based on two inputs. First, it is well-known in the field of irrigation engineering that each foot of elevation change is equal to 0.433 PSI of water pressure, and, therefore, each 2.31 ft. in elevation gain above the pivot point results in a loss of 1.0 PSI. Second, friction loss may be determined by irrigation engineering tables based on the pipe material, pipe diameter, pipe length, and static head pressure. By knowing the distance from the pivot point and the change in elevation from the pivot point to the max elevation for the pivot span together with pipe specifications, the SP can be computed, and can be used to adjust the pump motor speed by adjusting the Hz of the motor. Standard irrigation engineering formulas are available for calculating Total Dynamic Head (TDH=lift+elevation change+friction+pressure) and Water horsepower (WHP)=((GPM*TDH)/3960). These and associated calculations are used in calculating SP. Moreover, standard irrigation algorithms are well known to those familiar in the irrigation art.

The invention described herein applies to all grower inputs. For example, this invention may be applied to seeding. As discussed above with respect to irrigation, the invention may correlate seeding density and/or variety with crop performance, and may then prescribe adjustments to seeding density and/or variety.

The invention applies similarly to dry-land acreage as well as irrigated acreage. The system, tools, and procedures described herein are and have been used successfully on dry-land farms. That said, much of the description and discussion disclosed herein focuses on pressurized irrigation systems deploying center-pivot technology. The invention disclosed herein is not limited to irrigated acreage.

The foregoing disclosure is presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention.

The illustrations and descriptions of the invention herein have been simplified as appropriate to focus on elements essential to clearly understand the invention. Other elements may be desirable and/or required in order to implement the invention. However, because such elements are well known and do not facilitate a better understanding of the invention, a detailed discussion of such elements is not provided herein.

What is claimed is:

1. A method for applying a grower input to a field, comprising:
obtaining field characteristic, grower input, and crop performance data for one or more zones of a field;
applying statistical means to the obtained data to identify one or more grower inputs that correlate with crop performance;
identifying a zone of the field that may benefit from adjustment;
prescribing an adjustment to at least one grower input for the identified zone.

2. The method of claim 1, wherein field characteristic data comprises one or more of, or is based on one or more of, soil chemistry, pedal samples, topography, elevation, landscape change, slope, aspect, and soil compaction.

3. The method of claim 1, wherein crop performance data comprises one or more of, or is based on one or more of, yield and NDVI.

4. The method of claim 1, wherein a grower input is one of irrigation, tillage, fertility treatment, chemical treatment, and seeding.

5. The method of claim 1, wherein applying statistical means to identify one or more grower inputs that correlate with crop performance comprises employing linear regression, stepwise regression, or a combination of linear regression and stepwise regression.

6. The method of claim 1, further comprising providing a percent confidence for the identified one or more grower inputs that correlate with crop performance.

7. The method of claim 1, further comprising generating a predictive estimate of improvements to crop yield that may result from adjusting one or more of the identified one or more grower inputs that correlate with crop performance.

8. The method of claim 7, wherein generating a predictive estimate of improvements to crop yield comprises:
calculating the mean residual value for yields of zones yield beneath a regression slope;
computing a product of the r² and the mean residual value beneath the slope; and
dividing the product by the mean volume per acre over all zones in the field.

9. The method of claim 7, further comprising applying a modifier to the generated predictive estimate.

10. The method of claim 1, wherein identifying a zone that may benefit from an adjustment comprises employing linear regression with a scatter plot to identify underperforming zones.

11. The method of claim 1, wherein prescribing an adjustment to at least one grower input for the identified zone comprises:
identifying a grower input for adjustment and
calculating an adjustment based on a measure of central tendency for the identified grower input.

12. The method of claim 11, wherein prescribing an adjustment to at least one grower input for the identified zone further comprises:
determining that the calculated adjustment is outside of a variance; and
modifying the calculated adjustment so that it is within the variance.

13. The method of claim 11, wherein prescribing an adjustment to at least one grower input for the identified zone further comprises applying a modifier to the calculated adjustment

14. The method of claim 1, further comprising:
analyzing the actual effectiveness of the prescribed adjustment to the at least one grower input for the identified zone; and
further adjusting the at least one grower input for the identified zone.

15. A system for applying a grower input to a field, comprising:
a field data analytics (“FDA”) module configured to:
obtain field characteristic, grower input, and crop performance data for one or more zones of a field;
apply statistical means to the obtained data to identify one or more grower inputs that correlate with crop performance;
identify a zone of the field that may benefit from adjustment; and
a prescription calculator module configured to prescribe an adjustment to at least one grower input for the identified zone.

16. The method of claim 1, wherein field characteristic data comprises one or more of, or is based on one or more of, soil chemistry, pedal samples, topography, elevation, landscape change, slope, aspect, and soil compaction.

17. The method of claim 1, wherein crop performance data comprises one or more of, or is based on one or more of, yield and NDVI.

18. The method of claim 1, wherein a grower input is one of irrigation, tillage, fertility treatment, chemical treatment, and seeding.

19. The method of claim 1, wherein applying statistical means to identify one or more grower inputs that correlate with crop performance comprises employing linear regression, stepwise regression, or a combination of linear regression and stepwise regression.

20. A method for regulating irrigation pressure in a pivot irrigation system comprising:
computing water pressure to a span based on
elevation-change pressure loss; and
friction loss; and
regulating the water pressure to the span, based on the computed water pressure, such that the span delivers sufficient water pressure to each dropdown in the span.
